(19) United States
(12) Patent Application Publication
(10) Pub. No.: US 2026/0354945 A1
(43) Pub. Date: Nov. 12, 2026

(54) IMPLANT FOR SUPPORTING AN UPPER JAW DENTAL PROSTHESIS ON THE CRANIAL BONE

(71) Applicant: Karl Leibinger Asset Management GmbH & Co. KG, Mühlheim an der Donau (DE)

(72) Inventors: Nils-Claudius Gellrich, Hannover (DE); Thao Vu, Rietheim-Weilheim (DE); Frank Reinauer, Emmingen-Liptingen (DE); Philipp Pizzitola, Rottweil (DE); Björn Rahlf, Hannover (DE)

(21) Appl. No.: 19/719,736

(22) Filed: Jun. 25, 2026

Related U.S. Application Data
(63) Continuation of application No. PCT/EP2025/062033, filed on May 2, 2025.

(30) Foreign Application Priority Data
Jun. 12, 2024 (DE) 10 2024 116 468.9

(51) Int. Cl. A61C 8/00

(52) U.S. Cl. CPC A61C 8/0095; A61C 8/0018

(57) ABSTRACT

An implant (X) for supporting an upper jaw dental prosthesis (Z) on the cranial bone (S) includes a receiving portion (ZA) for receiving the upper jaw dental prosthesis (Z) and a plurality of attachment portions (B1, B2, B3, B4). The attachment portions (B1, B2, B3, B4) are connected to the receiving portion (ZA) and have at least one through hole (DL) for receiving a fastening screw (BT). A first attachment portion (B1) is designed to anchor the implant (X) in the lateral cranial base (S1), and a second and a third attachment portions (B2, B3) are each designed to anchor the implant (X) in one of the following three cranial bone sections (S2, S3, S4): in the pterygoid process (S2), in the zygomatic bone (S3), and in the maxilla (S4).

### CROSS-REFERENCE TO RELATED APPLICATION

The present application is related and has right of priority to German Patent Application No. DE 102024116468.9 filed on Jun. 12, 2024 and to PCT/EP2025/062033 filed at the European Patent Office on May 2, 2025, both of which are incorporated by reference in their entireties for all purposes.

### TECHNICAL FIELD

The invention relates generally to an implant for supporting an upper jaw dental prosthesis on the cranial bone, in particular in the case of loss or in the event of previous damage to parts of the upper jaw and/or of the midface.

### BACKGROUND

There are various causes of the partial or complete loss of parts of the upper jaw and/or of the midface. For example, the bone structure in this area can be heavily damaged due to trauma. In the case of a tumor in this area, it is frequently necessary to remove or irradiate the local bone structure. The bone structure can become damaged by the radiation therapy, such that an anchoring of an upper jaw dental prosthesis in the remaining local structure is unreliable. Systemic factors such as chemotherapy, immunotherapy, or the intake of medications affecting bone metabolism can also result in damage to this area.

For treating patients having a diagnosis of this type, it is known to attach an implant to the cranial bone in order to restore the missing or damaged structure. In such an implant, a support for an upper jaw dental prosthesis is preferably already provided. Alternatively, it is possible to initially build up the missing and/or damaged parts of the upper jaw and/or of the midface once again and, only after a healing phase of this reconstruction has been completed, to provide an upper jaw dental prosthesis. This lengthens the healing process of the patient, however.

WO 2016/198935 A1 describes a jaw implant for oral subperiosteal placement over the alveolar ridge of the upper jaw. The jaw implant has a J-shaped, L-shaped, or U-shaped body with a plurality of supporting areas which extend through the gingiva. The body has a plurality of extensions with attachment holes for attaching the implant to the jawbone, for example to the pyriform aperture, to the orbital margin, or to the zygomatic arch. In this approach, a large amount of foreign material is introduced in the vicinity of the reconstruction point, such that there is a risk of post-operative inflammation and/or an unreliable anchoring of the jaw implant. This is undesirable for the patient.

DE 10 2018 102 568 A1 describes an implant with a support structure which is provided for anchoring, following the contours of the bone, in a jawbone and/or a cranial bone. At least one post protrudes from the support structure, which post is designed to have a finished denture anchored thereto. Bridge parts designed for the remote attachment of the implant can protrude from the support structure. A specific embodiment of such a remote attachment is not described, however.

### BRIEF SUMMARY

Example aspects of the invention provide an implant for supporting an upper jaw dental prosthesis on the cranial bone, which implant is suitable in particular in the case of loss or in the event of previous damage to parts of the upper jaw and/or of the midface and does not require that these structural parts first undergo reconstruction.

In example aspects of the invention, an implant for supporting an upper jaw dental prosthesis on the cranial bone. To this end, the implant has a receiving portion for receiving the upper jaw dental prosthesis and a plurality of attachment portions connected to the receiving portion. The implant can be positioned on the skull by placing the attachment portions on the bony anatomy of the skull. Each of the attachment portions has at least one through hole for receiving a fastening screw, such that the implant can be anchored in the cranial bone in the correct position by a plurality of fastening screws.

According to example aspects of the invention, the attachment portions are formed at least by a first, a second, and a third attachment portion. The first attachment portion is designed to anchor the implant in the lateral cranial base. The second and the third attachment portions are designed to anchor the implant in further defined cranial bone sections, specifically in the pterygoid process, in the zygomatic bone, or in the maxilla. At least two of these three defined cranial bone sections are used to anchor the implant. For example, the second attachment portion can be provided for anchoring in the pterygoid process and the third attachment portion can be provided for anchoring in the zygomatic bone. Alternatively, the second attachment portion can be provided for anchoring in the pterygoid process and the third attachment portion can be provided for anchoring in the maxilla. According to a further alternative, the second attachment portion can be provided for anchoring in the zygomatic bone and the third attachment portion can be provided for anchoring in the maxilla.

The arrangement and design of the first attachment portion according to example aspects of the invention is based on the knowledge that anchoring the implant far away from the affected and possibly previously damaged structure of the parts of the upper jaw and/or of the midface considerably improves the chances that the implant will heal successfully. In addition, the exact positioning of the implant on the anatomy of the cranial bone is considerably improved by the geometrically wide support base. This is the case because, due to the use of the lateral cranial base as an anchoring support, the implant can be positioned substantially more precisely on the skull than is the case with conventional local support.

The arrangement and design of the first attachment portion according to example aspects of the invention results in a high mechanical load on the implant, however, since the distance between the application of force on the upper jaw dental prosthesis to be subsequently supported on the implant and the support on the lateral cranial base is relatively great. According to example aspects of example aspects of the invention, the arrangement and design of the second and the third attachment portions provide additional support for the forces on the cranial bone. Thus, an overloading of the anchoring in the first attachment portion is avoided in a simple way.

The implant according to example aspects of the invention is also distinguished by the fact that the implant can be fitted on the patient with relatively low invasiveness. The preparation for attaching the first attachment portion can take place, for example, transorally with subperiosteal preparation along the lateral midface to the preauricular area. The required preparation on the pterygoid process can also take place transorally.

Preferably, the implant has a fourth attachment portion, which is designed to anchor the implant in the remaining of the three cranial bone sections. In other words, the implant according to an example embodiment of this type is anchored in the lateral cranial base, in the pterygoid process, in the zygomatic bone, and in the maxilla. Due to such an example embodiment, a particularly stable anchoring with high positional accuracy is achieved.

Preferably, at least one of the attachment portions is provided in pairs. “In pairs” is understood to mean that a single attachment portion and a further single attachment portion, which are provided on different sides of the cranial bone for attachment to the same anatomy, are referred to using one term. Thus, if the implant has two individual attachment portions, both of which are used to anchor the implant in, for example, the lateral cranial base, these two individual attachment portions form a pair. Due to such an example embodiment, a bilaterally uniformly stable anchoring of the implant can be achieved. Two, three, or—if provided—all four attachment portions can be provided in pairs.

Preferably, the implant has a total of four or five attachment posts, which extend from the receiving portion. In such an example embodiment, the attachment portions are formed on the four or five attachment posts. Due to the example embodiment having exactly four or exactly five attachment posts, the implant can be particularly precisely arranged on the anatomy of the cranial bone.

Preferably, the attachment portion that is used to anchor the implant in the zygomatic bone is designed in such a way that the anchoring takes place in the root of the zygomatic arch. Such an example embodiment makes it possible to greatly relieve the load on the anchoring of the first attachment portion, such that the first attachment portion can be designed with a smaller cross-section. Thus, less foreign material is introduced into the patient.

According to one possible example embodiment, at least one of the attachment portions is designed in such a way that a portion of the implant rests directly against the zygomatic bone. The shape of the zygomatic bone supports the positioning of the implant on the cranial bone, such that the implant can be particularly precisely placed on the anatomy. In such an example embodiment, the portion of the implant that rests directly against the zygomatic bone is preferably designed in such a way that it at least partially engages around the zygomatic bone. In addition to the precise positioning, a good transmission of force from the implant to the cranial bone is therefore also made possible.

Preferably, the attachment portion that is used to attach the implant to the pterygoid process is designed in such a way that an attachment direction has an angle between 30 degrees and 60 degrees relative to the vertical, preferably an angle between 40 degrees and 50 degrees, particularly preferably an angle of 45 degrees. The “vertical” is understood to mean the longitudinal axis of the anatomy. Such a geometry facilitates the anchoring of the implant with the lower jaw open in the surgical site, since the required drilling and screwing devices are more accessible.

According to a preferred example embodiment, the attachment portion that is used to anchor the implant in the pterygoid process has precisely one or two through holes for receiving one fastening screw each. Due to such an example embodiment, a geometric over-determination of the implant position can be avoided in a simple way. If the attachment portion for anchoring the implant in the pterygoid process is provided in pairs, such that the implant can be attached to the right and the left pterygoid process, each attachment portion half has one or two through hole(s)—one for the attachment to the right pterygoid process and one for the attachment to the left pterygoid process.

Preferably, the first attachment portion extends substantially horizontally along the lateral cranial base. Due to an example embodiment of this type, the transoral introduction and the subperiosteal preparation are simplified.

Preferably, the first attachment portion has a plurality of through holes for receiving fastening screws, particularly preferably more than five through holes. The number “five” relates to a single attachment portion, such that a first attachment portion formed as a pair is therefore provided with at least ten through holes. Due to the high number of through holes, the first attachment portion can be anchored in the lateral cranial base in a particularly stable manner. It is not required for all through holes to be actually used to anchor the implant.

Preferably, the first attachment portion is designed in such a way that at least one of the through holes for anchoring the implant is arranged in close proximity to the mandibular joint. As a result, particularly good support is provided for the biting forces between the upper jaw and the lower jaw, which can even exceed support provided when dentition is complete and not impaired.

Preferably, an extension is arranged on at least one of the attachment portions, which extension points away from the direction of extent of the attachment portion and is bent. Due to this example embodiment, the positioning of the implant on the anatomy can be improved and additionally defined.

Preferably, the implant is formed as one piece. The implant can be manufactured, for example, by 3D printing or by milling from a single blank, for example made of titanium or steel. Due to an example embodiment of this type, a joining point is not necessary, which could weaken the stability of the implant.

Preferably, at least one of the attachment portions has a marking for indicating the position of a sensitive tissue section such as nerves, brain, CSF fistulas, or vessels. Due to such a marking, the surgeon is assisted in attaching the implant by sensitive tissue being indicated directly on the implant.

Preferably, the implant is designed in such a way that it can be arranged in only one single position on the cranial bone, such that an incorrect orientation is already ruled out due to the geometry of the implant. Embodiments are also conceivable, however, in which the implant geometry intentionally allows for a small amount of play when arranged on the cranial bone.

### BRIEF DESCRIPTION OF THE DRAWINGS

Exemplary embodiments of the invention are described in detail with reference to the figures. Wherein:

FIGS. 1-2 show different views of an implant according to a first exemplary embodiment;

FIGS. 3-4 show different views of an implant according to a second exemplary embodiment;

FIG. 5 shows a detailed view of the implant according to the second exemplary embodiment;

FIG. 6 shows a detailed view of a placement of the implant on the zygomatic bone;

FIG. 7 shows a detailed view of an attachment portion; and

FIGS. 8-9 show further views of the implant according to the first exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

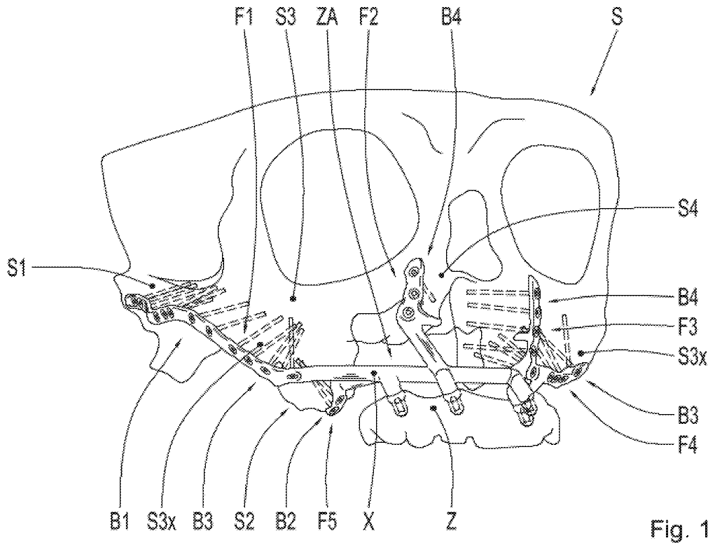

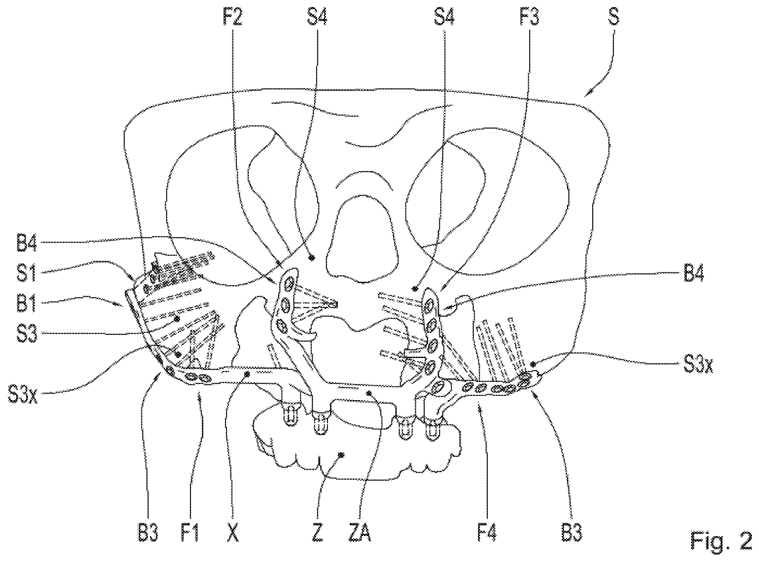

FIG. 1 and FIG. 2 each show a view of an implant X according to a first exemplary embodiment. In the representation according to FIG. 1 and FIG. 2, the implant X is positioned relative to a cranial bone S, specifically precisely in the position in which the implant X is to be anchored in the cranial bone S in an operation. The implant X is used to support an upper jaw dental prosthesis Z on the cranial bone S. To this end, the implant X has a receiving portion ZA to which the upper jaw dental prosthesis Z can be attached. Connected to the receiving portion ZA are first, second, third, and fourth attachment portions B1, B2, B3, B4, via which the implant X can be attached to the cranial bone S at different points. Each of the attachment portions B1, B2, B3, B4 has at least one through hole, which is provided for receiving a fastening screw. Thus, the implant X can be fixedly connected to the cranial bone S by a plurality of fastening screws. The fastening screws are not shown in FIG. 1 and FIG. 2. Instead, the screw insertion vectors are shown, in order to clearly show the eventual orientation of the fastening screws.

Depending on the bony anatomy that is available, the implant X can be attached at the same point on each side of the cranial bone S. In the exemplary embodiment shown in FIG. 1 and FIG. 2, for example, there is unilateral attachment to the pterygoid process S2 and bilateral attachment to the zygomatic bone S3 and to the maxilla S4. The attachment to the lateral cranial base takes place only to the lateral cranial base S1 on the right from a patient perspective, but not to the lateral cranial base on the left.

In the exemplary embodiment according to FIG. 1 and FIG. 2, the implant X has a total of five attachment posts F1, F2, F3, F4, F5 extending from the receiving portion ZA. The attachment portions B1, B2, B3, B4 are formed on the attachment posts F1, F2, F3, F4, F5. The attachment post F1 extends from the receiving portion ZA toward the lateral cranial base S1 on the right from a patient perspective. The first attachment portion B1 is formed on the attachment post F1 in order to be able to attach the implant X to the right lateral cranial base S1 by a plurality of fastening screws. Furthermore, the right half of the third attachment portion B3 is formed on the attachment post F1. The second attachment portion B2 is formed on the attachment post F5. Via the second attachment portion B2, the implant X can be attached to the right pterygoid process S2. Via the right half of the third attachment portion B3, the implant X can be attached to the zygomatic bone S3; in the exemplary embodiment according to FIG. 1 and FIG. 2, to the root of the zygomatic arch S3x.

The attachment post F2 and the attachment post F3 extend from the receiving portion ZA in the direction of the maxilla S4. The right half of the fourth attachment portion B4 is formed on the attachment post F2. The left half of the fourth attachment portion B4 is formed on the attachment post F3. The two individual halves of the fourth attachment portion B4 together form an attachment portion pair in order to bilaterally attach the implant X to the maxilla S4. The attachment post F4, on which the left half of the third attachment portion B3 is formed, extends from the receiving portion ZA. Via the left half of the third attachment portion B3, the implant X can be attached to the root of the left zygomatic arch S3x.

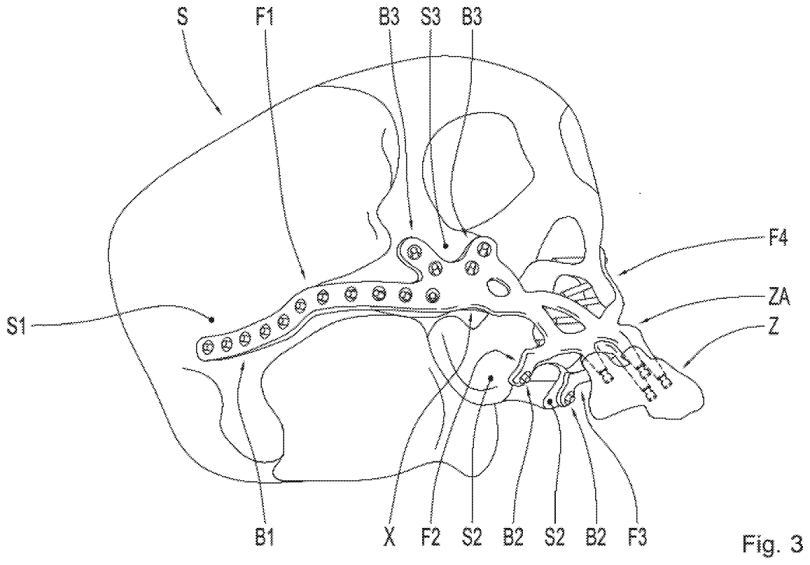

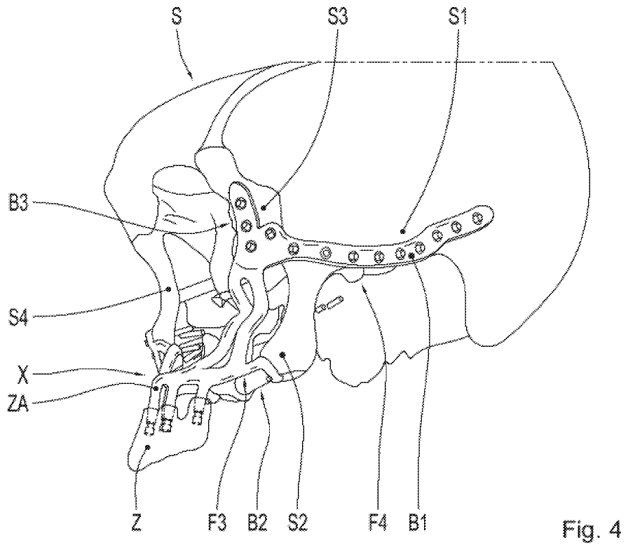

FIG. 3 and FIG. 4 each show a view of an implant X according to a second exemplary embodiment, which differs considerably in terms of design from the first exemplary embodiment shown in FIG. 1 and FIG. 2. This makes it clear that the specific geometric design of the implant X depends on the individual situation of the patient and thus is to be adapted in a patient-specific manner. The second exemplary embodiment shown in FIG. 3 and FIG. 4 is provided for reconstruction after a gunshot wound. The exemplary embodiment of the implant X according to FIG. 3 and FIG. 4 has precisely four attachment posts F1, F2, F3, F4, which extend from the receiving portion ZA. The right half of the first attachment portion B1 is arranged on the attachment post F1 in order to be able to attach the implant X to the right lateral cranial base S1. Furthermore, the right half of the third attachment portion B3 is arranged on the attachment post F1 in order to be able to attach the implant to the left zygomatic bone S3. The right half of the second attachment portion B2 is associated with its own attachment post F2 in order to attach the implant X to the right pterygoid process S2. The left half of the second attachment portion B2 is also associated with its own attachment post F3 in order to attach the implant X to the left pterygoid process S2. The left half of the first attachment portion B1 is formed on the attachment post F4 in order to be able to attach the implant X to the left lateral cranial base S1. Furthermore, the left half of the third attachment portion B3 is arranged on the attachment post F4 in order to be able to attach the implant X to the left zygomatic bone S3.

The implant X according to the second exemplary embodiment shown in FIG. 3 and FIG. 4 is therefore bilaterally attached to three cranial bone sections: to the lateral cranial base S1, to the pterygoid process S2, and to the zygomatic bone S3. The individual halves of the attachment portions B1, B2, B3 each form an attachment portion pair.

In FIG. 3 and FIG. 4, it is clearly apparent that the left and the right halves of the attachment portion B2 each have precisely one through hole for receiving precisely one fastening screw in order to attach the implant X to the left and the right pterygoid process S2.

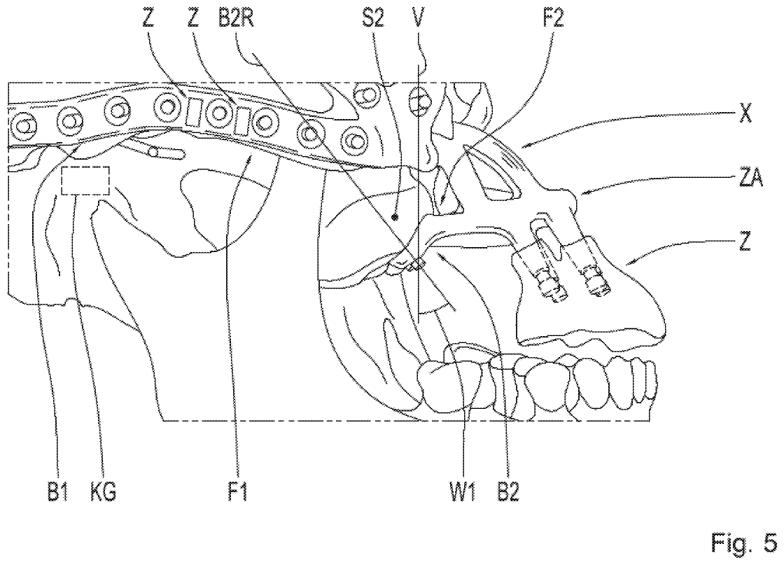

FIG. 5 shows a detailed view of the implant X according to the second exemplary embodiment. Two markings Z are arranged on the implant X on the left half of the first attachment portion B1. The markings Z could be formed, for example, by indentations, a roughened surface, or a color anodization. The markings Z show the position of sensitive tissue sections present in this area, such as nerves, brain, CSF fistulas, or vessels. Thus, the surgeon can be appropriately assisted in the preparation and subsequent attachment of the implant X. This is embodiment is to be regarded only as an example. The markings Z could be arranged at any other relevant point on the implant X.

FIG. 5 further shows the right half of the second attachment portion B2 in detail, via which the implant X can be attached to the right pterygoid process S2. In this representation, it is clearly apparent that the second attachment portion B2 is designed in such a way that an attachment direction B2R for attaching the implant X to the pterygoid process S2 is oriented at an angle W1 of approximately 45 degrees relative to the vertical V. Of course, the specific attachment direction B2R depends on the individual case, such that the angle W1 is usually in a range between 30 degrees and 60 degrees relative to the vertical V.

In FIG. 5, it is clearly apparent that the first attachment portion B1 is designed in such a way that the implant X can be anchored in the lateral cranial base S1 in close proximity to the position of the mandibular joint KG.

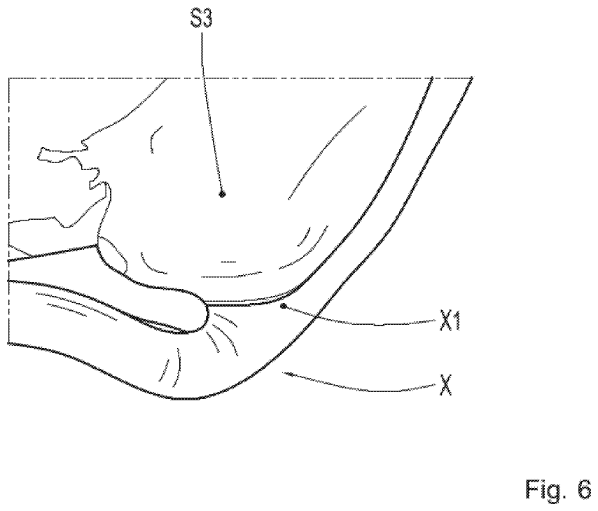

FIG. 6 shows a detailed view of a placement of the implant X on the zygomatic bone S3. The implant X rests directly against the zygomatic bone S3 at a portion X1. This portion X1 at least partially engages around the zygomatic bone S3. As a result, a good transmission of force from the implant X to the cranial bone S is made possible.

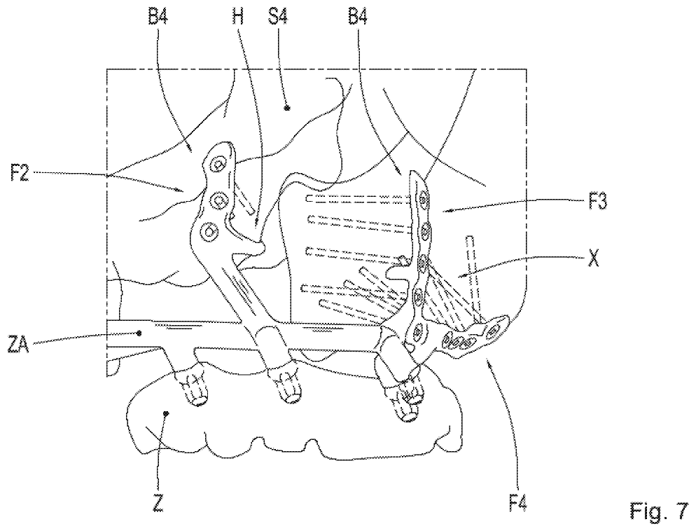

FIG. 7 shows a detailed view of the fourth attachment portion B4 of the first exemplary embodiment of the implant X shown in FIG. 1. An extension H is arranged on the right half of the fourth attachment portion B4, which extension points away from the direction of extent of the fourth attachment portion B4 and is bent. Due to this example embodiment, the positioning of the implant X on the anatomy of the maxilla S4 can be improved.

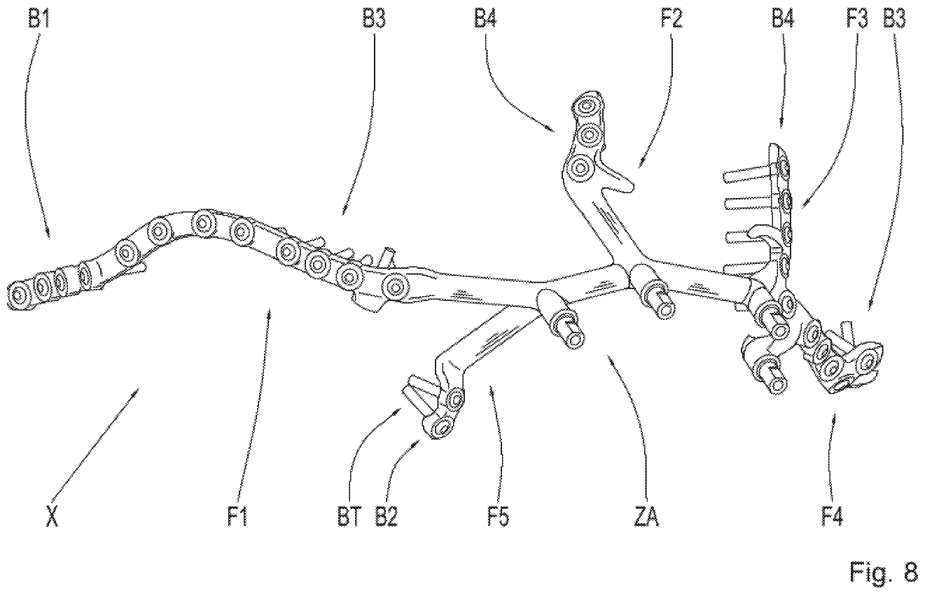

FIG. 8 shows a view of the implant X according to the first exemplary embodiment shown in FIG. 1 and FIG. 2. In this view, the implant X is shown without the cranial bone S and without the upper jaw dental prosthesis ZA. In FIG. 8, the fastening screws BT are shown instead of the screw insertion vectors shown in FIG. 1 and FIG. 2. The length of the fastening screws BT shown in FIG. 8 is to be regarded only as an example. The surgeon would select screw lengths deviating therefrom depending on the individual situation of fixation to the cranial bone S.

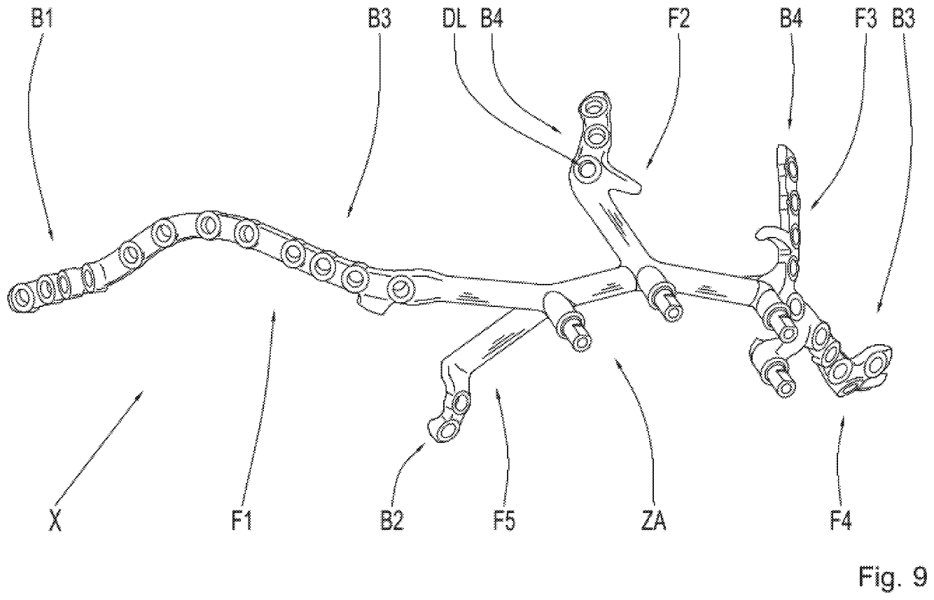

FIG. 9 shows a further view of the implant X according to the first exemplary embodiment shown in FIG. 1 and FIG. 2. In this view, the implant X is shown without the cranial bone S and without the fastening screws BT, such that the attachment holes DL are visible; labeled on the attachment post F2 in FIG. 9 by way of example. Furthermore, it is clearly apparent in FIG. 9 that the implant X is formed in one piece.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

List of reference characters

| | |
|---|---|
| X | implant |
| X1 | portion of the implant |
| S | cranial bone |
| S1 | lateral cranial base |
| S2 | pterygoid process |
| S3 | zygomatic bone |
| S3x | root of the zygomatic arch |
| S4 | maxilla |
| Z | upper jaw dental prosthesis |
| ZA | receiving portion |
| F1 | attachment post |
| F2 | attachment post |
| F3 | attachment post |
| F4 | attachment post |
| F5 | attachment post |
| B1 | first attachment portion |
| B2 | second attachment portion |
| B3 | third attachment portion |
| B4 | fourth attachment portion |
| BT | fastening screw |
| DL | through hole |
| W1 | angle |
| V | vertical |
| H | extension |
| Z | marking |
| KG | position of the mandibular joint |

1-15: (canceled)

16. An implant (X) for supporting an upper jaw dental prosthesis (Z) on the cranial bone (S), comprising:
a receiving portion (ZA) for receiving the upper jaw dental prosthesis (Z); and
a plurality of attachment portions (B1, B2, B3, B4) connected to the receiving portion (ZA) and having at least one through hole (DL) for receiving a fastening screw (BT), the attachment portions (B1, B2, B3, B4) comprising at least a first attachment portion (B1), a second attachment portion (B2), and a third attachment portion (B3), wherein the first attachment portion (B1) is configured to anchor the implant (X) in the lateral cranial base (S1), and wherein the second and the third attachment portions (B2, B3) are each configured to anchor the implant (X) in a respective one of the pterygoid process (S2), the zygomatic bone (S3), and the maxilla (S4).

17. The implant (X) of claim 16, wherein the attachment portions (B1, B2, B3, B4) comprise a fourth attachment portion (B4) configured to anchor the implant (X) in the remaining one of the pterygoid process (S2), the zygomatic bone (S3), and the maxilla (S4).

18. The implant (X) of claim 16, wherein at least one of the attachment portions (B1, B2, B3, B4) is formed as a pair.

19. The implant (X) of claim 16, further comprising a total of four or five attachment posts (F1, F2, F3, F4, F5) extending from the receiving portion (ZA), wherein the attachment portions (B1, B2, B3, B4) are formed on the attachment posts (F1, F2, F3, F4, F5).

20. The implant (X) of claim 16, wherein the attachment portion (B3) that is used to anchor the implant (X) in the zygomatic bone (S3) is configured such that the anchoring takes place in a root of the zygomatic arch (S3x).

21. The implant (X) of claim 16, wherein at least one of the attachment portions (B1, B2, B3, B4) is configured such that a portion (X1) of the implant (X) rests directly against the zygomatic bone (S3).

22. The implant (X) of claim 21, wherein the portion (X1) of the implant (X) that rests directly against the zygomatic bone (S3) is configured such that the portion (X1) at least partially engages around the zygomatic bone (S3).

23. The implant (X) of claim 16, wherein the attachment portion (B2) that is configured to attach the implant (X) to the pterygoid process (S2) is configured such that an attachment direction (B2R) has an angle (W1) between thirty degrees and sixty degrees relative to vertical (V).

24. The implant (X) of claim 16, wherein the attachment portion (B2) that is configured to anchor the implant (X) in the pterygoid process (S2) has precisely one or two through holes (DL) for receiving one fastening screw (BT) each.

25. The implant (X) of claim 16, wherein the first attachment portion (B1) extends substantially horizontally along the lateral cranial base (S1).

26. The implant (X) of claim 16, wherein the first attachment portion (B1) has a plurality of through holes (DL) for receiving fastening screws (BT).

27. The implant (X) of claim 26, wherein the first attachment portion (B1) is configured such that at least one of the through holes (DL) for anchoring the implant (X) is arranged in close proximity to the mandibular joint (KG).

28. The implant (X) of claim 16, further comprising an extension (H) arranged on at least one of the attachment portions (B4), wherein the extension (H) pointing away from a direction of extent of the attachment portion (B4) and is bent.

29. The implant (X) of claim 16, wherein the implant (X) is formed as one piece.

30. The implant (X) of claim 16, wherein at least one of the attachment portions (B1) has a marking (Z) for indicating a position of a sensitive tissue section.

31. The implant (X) of claim 16, wherein the sensitive tissue section comprises nerves, brain tissue, CSF fistulas, or vessels.
